(19) United States
(12) Patent Application Publication
(10) Pub. No.: US 2017/0078896 A1
(43) Pub. Date: Mar. 16, 2017

(54) USING NETWORK-PROVIDED INFORMATION TO TUNE WIRELESS NETWORK CLIENT PERFORMANCE

(71) Applicant: Laird Technologies, Inc., Earth City, MO (US)

(72) Inventors: Daniel B. Kephart, JR., Cuyahoga Falls, OH (US); Andrew Dobbing, Alyesbury (GB); Kris A. Sidle, Macedonia, OH (US); Donald Cyril Ferencz, JR., Cleveland, OH (US); Kevin David Hostelley, Strongsville, OH (US); Jeffrey R. Adams, Louisville, OH (US); Douglas Andrew Smith, Stouffville (CA)

(21) Appl. No.: 15/167,473

(22) Filed: May 27, 2016

Related U.S. Application Data
(60) Provisional application No. 62/217,304, filed on Sep. 11, 2015.

(51) Int. Cl. H04W 24/02; H04L 12/24

(52) U.S. Cl. CPC H04W 24/02; H04L 41/0823

(57) ABSTRACT

According to various aspects, exemplary embodiments are disclosed of systems and methods for dynamic configuration of wireless clients and infrastructure in wireless networks, to tune client performance. A network embodiment includes a wireless network infrastructure and a plurality of devices having clients integrated therewith and configured for wireless communication via the wireless infrastructure and for communication with a server. Each client may acquire data relevant to network conditions affecting performance by the client in the network, and may send the acquired data to the server. Based on the acquired data, the server sends instruction to one or more of the clients via the wireless infrastructure to adjust operating parameter(s) to tune client performance in the network.

### FIELD

The present disclosure relates generally to systems and methods for dynamic configuration of wireless clients and infrastructure in wireless networks to facilitate optimized network performance and improvements in the ability of client radios to continue to operate optimally within the given network environment. The disclosure also relates to alerting devices, software, and/or users on or a part of a wireless network to issues related to wireless connectivity.

### BACKGROUND

This section provides background information related to the present disclosure which is not necessarily prior art.

Wireless communication networks are becoming ubiquitous. As wireless networking has become commonplace, configurations of network hardware and software have become increasingly sophisticated, along with a widening range of device types being incorporated into wireless networks.

### DRAWINGS

The drawings described herein are for illustrative purposes only of selected embodiments and not all possible implementations, and are not intended to limit the scope of the present disclosure.

FIG. 1 is a diagram of a device with which a software client may be integrated for wireless communication according to an exemplary embodiment;

FIG. 2 is a diagram of a communications network or system according to an exemplary embodiment;

FIG. 3 is a diagram of a communications network or system in a hospital environment according to an exemplary embodiment; and

FIG. 4 is a flow diagram of a genetic algorithm according to an exemplary embodiment.

Corresponding reference numerals indicate corresponding parts throughout the several views of the drawings.

### DETAILED DESCRIPTION

Example embodiments will be described more fully with reference to the accompanying drawings.

The inventors have observed that wireless network optimization strategies typically fall into three categories. The first strategy type is to optimize the network during wireless infrastructure layout. This usually involves obtaining site layouts, area maps, user density and other similar information. This may be followed by modelling simulations to determine the approximate placement of wireless access points, base stations, radio heads, and antennas. A network designer may additionally determine locations based on past experience. A decision on devices to be utilized in the infrastructure may depend on a chosen technology, e.g., 802.11a/b/g/n/ac, LTE, or other WLAN and WWAN technologies. For indoor 802.11 wireless technology and other small cells, access points typically are installed and a technician may carry out a final survey employing a measurement device to confirm that sufficient coverage has been achieved. For outdoor WWAN applications like LTE, cell sites typically are installed and a vehicle may be driven around that can confirm that sufficient coverage has been achieved.

The second strategy type may be performed after an initial installation has occurred. During normal operation and maintenance periods, a wireless infrastructure may adjust the network configuration and base station and/or access point parameters to optimize usage. In order to decide to make an adjustment, wireless infrastructure gathers data about the environment. This could be determining the number and usage of clients on a given base station or access point, doing scans and passive monitoring to determine channel usages, asking a client to do scans to determine channel usage, and making other data gathering attempts. In order to optimize the wireless network, the infrastructure may take action. For 802.11 wireless, this could include de-authenticating a client on an access point in order to attempt to move it to a different access point, adjusting access point power, moving access points to less used channels, and other actions. For licensed spectrum technologies like UMTS or LTE, this may include the base network instructing the client to alter its power, bit encoding scheme or move to another base station controller to improve the network performance.

The third strategy type is to install a fixed overlay network of sensors that monitor wireless network infrastructure. The sensors may passively monitor or actively test the wireless network to see how well it is performing. Passive monitoring may be used to determine channel usage, base station or access point transmit power, client interaction with base stations or access points, base station or access point interaction with clients, and gather other data. Active testing may include connecting to each base station or access point, trying different authentication, trying different modulation and rate schemes, throughput tests, differing protocol based tests, and other active testing. Metrics and data gathered from the tests may be analyzed. After analysis, the system may give recommendations to allow network engineers to manually adjust the wireless network for better performance.

Most wireless network installations have gone through the first strategy type and employ the second strategy type. The third strategy type is less common but is a developing area of wireless network management. It should be noted that all three strategy types focus on optimizing the wireless infrastructure and not the wireless clients. The inventors have observed that wireless clients can play a key role in providing optimal connectivity on a wireless network and that wireless client optimization is an underdeveloped area.

A commonly used strategy to optimize client parameters such as transmit power, roam threshold, and scan periods may be performed before commissioning a network module to the field. Typically, a wireless chipset or module manufacturer sets optimal default parameters for all applications to use. Occasionally, a specific manufacturer integrating a wireless chipset or module may optimize its client parameters for its specific use case. Less commonly, a network administrator may modify default parameters to provide optimal client performance under the conditions of a specific network as a whole. In most if not all cases, these client optimizations are static once made and apply to the client's operation throughout the network.

A lesser-used strategy focuses on RF interference and regulatory optimization. A network infrastructure may suggest a transmit power value different than a pre-programmed value of a module operating in the field. One reason may be because an access point or base station is especially crowded and a client is potentially interfering with other clients. Another reason may be due to local regulatory requirements requiring power levels different from those at which the module was originally intended to operate.

In various embodiments of the present disclosure, performance of wireless communication in a network by a plurality of software clients provided on and/or integrated with various devices can be tuned through a wireless client/server-based management system. Notably, in various embodiments, tuning can be performed based on information acquired by the network clients, e.g., from the wireless infrastructure.

Although various embodiments are described with reference to medical devices, monitoring devices and hospital operations, the disclosure is not so limited. Aspects of the disclosure may be practiced in connection with various types of devices distributed in various types of environments. Unless indicated otherwise herein, the term “device” is used to refer to a mechanical and/or electrical contrivance for a particular purpose. In various embodiments, a “device” provides functionality that may or may not be supported by a general-purpose computer. Further, unless indicated otherwise herein, “device” refers to a contrivance that might include and/or make use of a general-purpose computer but is not itself a general-purpose computer.

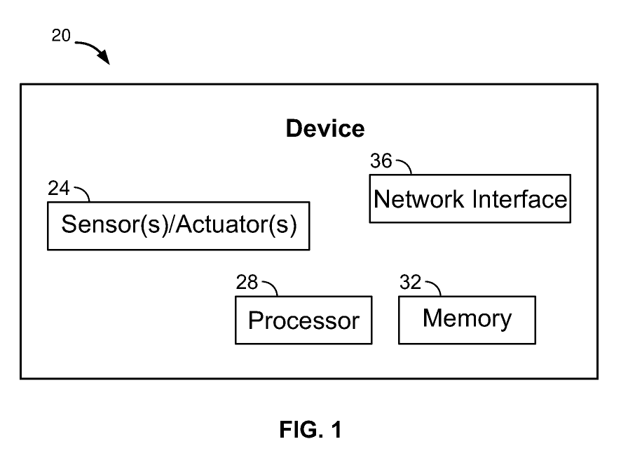

Referring to the figures, FIG. 1 illustrates an example embodiment of a device 20 with which a software client may be integrated for wireless communication according to an exemplary embodiment. The device 20 may be, e.g., a medical device or monitoring device for use in a hospital setting. The device 20 may include one or more sensors and/or one or more actuators 24. For example, in an embodiment in which the device 20 is a patient monitor system, sensor(s) may include sensors detecting the heart rate, temperature and blood pressure of a patient, and actuator(s) may include an alarm configured to send a signal to a nurses' station when any of these vital signs fall or rise outside prescribed levels. In the example embodiment shown in FIG. 1, the device 20 includes a processor 28 operatively connected with memory 32 and a network interface 36. In various embodiments, a processor, memory and network interface may be provided as a single unit included in and/or connected with a device. In some other embodiments, a processor, memory and network interface may be provided as separate components of and/or connected with a device. The example network interface 36 may include, without limitation, a wireless network adapter, a wired network adapter, a mobile telecommunications adapter, and/or other device(s) capable of communicating with one or more various networks.

The example processor 28 may include, without limitation, one or more processing units including, e.g., a central processing unit (CPU), a microcontroller (MCU), a reduced instruction set computer (RISC) processor, an application-specific integrated circuit (ASIC), a programmable logic circuit (PLC), a gate array, and/or any other circuit and/or processor capable of performing operations and functions as described herein. The above examples are not intended to limit in any way the definition and/or meaning of “processor.” The processor 28 and memory 32 are devices that enable information, such as executable instructions and/or other data, to be stored and retrieved.

The example memory 32 may include one or more computer-readable media, such as, without limitation, dynamic random access memory (DRAM), static random access memory (SRAM), read-only memory (ROM), erasable programmable read-only memory (EPROM), solid state device(s), flash drive(s), CD-ROM, thumb drive(s), tape(s), flash drive(s), hard disk(s), and/or any other type of volatile or nonvolatile physical or tangible computer-readable medium. Furthermore, in various embodiments, processor-executable instructions may be stored in the memory 32 for execution by the processor 28 to cause the processor 28 to perform one or more functions as described herein, such that the memory 32 is a physical, tangible, and non-transitory computer-readable medium. It should be appreciated that the memory 32 may include a variety of different memories, each implemented in one or more of the functions or processes described herein. In various embodiments, the memory 32 may be configured to provide a software client executable by the processor 28 for communicating in a wireless network that may include, e.g., a plurality of clients integrated with various devices 20.

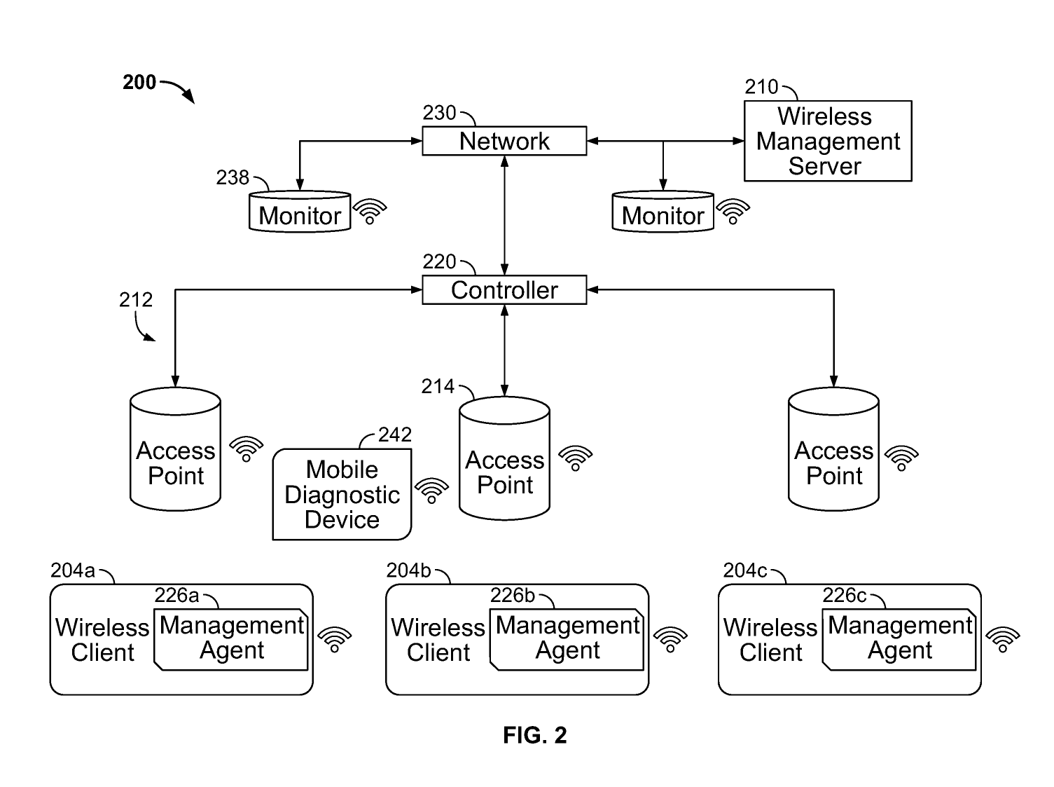

An example embodiment of a communications network or system is indicated generally in FIG. 2 by reference number 200. The system 200 may be used, e.g., for managing actions performable by a plurality of distributed devices each having a wireless client 204. Three example wireless clients 204a, 204b and 204c are shown in FIG. 2. A wireless management server 210 is configured to communicate in a wireless server-client network 212 with the wireless clients 204 via a plurality of APs (access points) 214. A controller 220 is provided to control resources of the network 212, including (without limitation) the APs 214. Each wireless client 204 has a management agent 226 (example agents 226a, 226b and 226c being shown in FIG. 2.) Each agent 226 is configured to collect data and/or events related to the wireless connection.

The wireless management server 210 is in communication with a fixed overlay monitoring network 230 that includes monitoring devices 238. One or more mobile diagnostic devices 242, one of which is included in the embodiment shown in FIG. 2, may also be provided. Such devices may include, e.g., smartphones, laptops, purpose-build wireless sniffers, and/or other devices. Other or additional wireless infrastructure components may be included in various embodiments.

In various wireless network embodiments, including without limitation the example embodiment of FIG. 1, each client has unique data and events related to how well it and the network are performing. The individual wireless client data can be collected by an agent that may then send it on to a wireless management server to store and analyze. The agent may also do preliminary analysis and send that with or without the raw data to the wireless management server. The agent may also send the current wireless client configuration parameters to the wireless management server, e.g., where the server does not already have the current parameters. Example 802.11 wireless client configuration parameters may include, e.g., SSID, authentication type, roam scan period, background scan period, scan channel dwell time, bitrate selection, transmit power, etc. Example 802.11 wireless client data may include, e.g., each client's current AP BSSID, AP RSSI, recent client roam table results, recent client scan results, packet retry counts, and channel utilization, station count, admissions capability numbers from AP, etc. Examples of events from an 802.11 wireless client may include, e.g., association, authentication, roam events with reasons as to why a given event succeeded or failed, etc.

When a wireless management server has collected sufficient data and events from a given wireless client, it can perform analysis to determine if the wireless client is experiencing connectivity problems. If the client is experiencing connectivity problems, the wireless management server may attempt to identify the cause of the connectivity problem. If the wireless management server needs further data from the wireless client, it may instruct the client's agent to send more verbose data and events.

If there are nearby wireless clients, the wireless management server may compare the nearby clients' data and events to see if any are experiencing similar connectivity issues. If this is still not sufficient, the wireless management server may instruct a nearby wireless client's agent to put the client into sniffer or monitor mode. In this mode, the nearby client may collect wireless traces of the wireless client having connectivity issues.

In various embodiments, if there is nearby fixed wireless network diagnostic infrastructure, its data and/or events may be leveraged to identify connectivity issues. This may be, for example, an overlay network with fixed monitoring nodes. A fixed overlay network may gather data and send events, e.g., by active testing and passively sniffing the network. This data may be sent to and managed by the wireless management server.

If there are nearby mobile wireless network diagnostic devices, their data and events may be leveraged to identify connectivity issues. This may include mobile wireless devices such as smartphones, laptops, purpose build wireless sniffers, and other devices. Such devices may be moved around, e.g., by a facility staff, field engineers, drones, and/or robot-like devices programmed to move around the facility. Such mobile wireless network diagnostic devices may gather data and send events by active testing and passively sniffing the network. This data could be sent to and managed by the wireless management server.

Nearby wireless clients, fixed wireless network diagnostic infrastructure, and/or mobile wireless network diagnostic devices in sniffer or monitor mode (a sniffer) may coordinate with a given wireless client's agent. Such coordination may include a wireless management server or a specific wireless client's agent coordinating with the sniffer to allow it to move to appropriate channels, what packet types to look for, when to start sniffing, etc. Such coordination may ensure that needed data is captured. Such coordination may be done, e.g., over the wireless client's connection to wireless infrastructure, over a separate wireless connection between the sniffer and the wireless client such as Bluetooth or 802.11 connection, and/or over a physical network connection to the sniffer such as Ethernet or serial.

Data and events, if any, from wireless network infrastructure may be leveraged to identify connectivity issues. This could take the form of direct data and events from wireless network equipment such as a controller or access point. It could also take the form of data and events determined by monitoring and or sniffing communication between a controller and access points on the wired network. Access points and controllers are not the only infrastructure equipment that could be used in such fashion. Any wireless network infrastructure typically may have data and events gathered from it. In various embodiments, such data may be sent to and managed by a wireless management server.

If there is historical data, a wireless management server may compare that data and events to determine whether previous similar connectivity issues were found. This could be from previous clients, mobile diagnostic devices, and/or fixed diagnostic infrastructure in the network area. This could include historical information from a nearby fixed network. In various embodiments, such data may be sent to and managed by a wireless management server.

Additionally or alternatively, user-driven input may be used to identify wireless connectivity issues. For example, a user may press a button to log that a wireless network connectivity problem has occurred. As another example, results of user-activated active testing and/or passive wireless sniffing may be used as input to identify wireless connectivity issues. In various embodiments, such data may be sent to and managed by a wireless management server.

Location-based input may be used to assist in identifying where a wireless connectivity issue is occurring. This may come from 802.11 based location information such as signal strength, time of flight, what networks are seen, etc. Such location information may also come from radio frequency identification (RFID), Bluetooth Low Energy (BLE) beacons, GPS, other technologies, etc. In various embodiments, such data may be sent to and managed by a wireless management server.

In some embodiments, when connectivity issues have been identified, a wireless management server may determine whether any wireless client configuration parameters on a given client or clients could be adjusted to optimize connectivity. If the wireless management server determines that the configuration parameters on a given client or clients can be optimized, it may send those new parameters to the clients' agents for them to take effect at an appropriate time.

If connectivity issues are related to wireless infrastructure, a wireless management server may send an alert and/or may recommend, to a wireless network administrator, corrective action to apply to the wireless infrastructure. This may include changing infrastructure parameters and/or recommendations as to the physical layout of the infrastructure. In some embodiments in which a wireless management server is allowed to directly interface and control the wireless infrastructure, the wireless management server may take corrective action automatically.

If a user of a given wireless device or a program on a given wireless device needs to know about a connectivity issue, the agent integrated with that device may be configured to trigger an alert to the program or user. This may allow a user to take potentially corrective action such as moving the device to an area of better connectivity. Additionally or alternatively, a program on a wireless device may make determinations as to how much data and when to send it based on such alerts.

Diagnosing and/or optimizing for connectivity issues could take many forms. For example, a connectivity issue may be determined based on field diagnostic practices and their corresponding optimizations. Such practices may be preprogrammed as algorithms, e.g., in a wireless management server and/or client agents. Various embodiments that may be preprogrammed as algorithms are described in Tables 1-18.

TABLE 1
Detect and optimize for edge of coverage

| | |
|---|---|
| Optimization Objectives | Alert user device and server side, optimize wireless client to |
| | hold onto connection. |
| Required events/data | Each client's current AP BSSID and RSSI, recent client roam |
| | table results, recent client scan results. |
| Analysis/Algorithm | Detect if any clients have a weak signal strength to their |
| | currently connected AP and no better roam candidates. |
| Required control parameters | Roam scan period, background scan period, scan channel |
| | dwell time, bitrate selection, transmit power, device alert |
| | trigger, server side alert trigger. |
| Required parameter changes | Decrease the roam scan and background scan period or turn it |
| | off, enable low speed bitrates, decrease scan channel dwell |
| | time, increase transmit power, trigger device alert, trigger |
| | server side alert. |
| Desired Outcome | Allow the wireless client to maintain connection for as long as |
| | possible until signal strength improves or reaches out of |
| | coverage scenario. Trigger an alert on the wireless client's |
| | device to inform device software and on any server side |
| | software of poor coverage area. Trigger server side alert of |
| | devices in poor coverage area. |

TABLE 2
Detect and optimize for signal strength under-coverage

| | |
|---|---|
| Optimization Objectives | Alert user device and IT staff as to coverage issues, optimize |
| | wireless client to hold onto connection. |
| Required events/data | Each client's current AP BSSID and RSSI, recent client roam |
| | table results, recent client scan results, known client |
| | disconnects and length of disconnect. |
| Analysis/Algorithm | Detect if any clients have a weak signal strength to their |
| | currently connected AP and no better roam candidates. Also, |
| | detect if clients are connecting and disconnecting often due to |
| | lack of signal. Use historical analysis to determine if this is a |
| | regular problem for clients near certain APs. |
| Required control parameters | Roam scan period, background scan period, roam threshold, |
| | scan channel dwell time, bitrate selection, transmit power, |
| | device alert trigger, server side alert trigger. |
| Required parameter changes | Change the roam scan period, background scan period, and |
| | roam threshold to optimize device's main task vs. maintaining |
| | a link, enable low speed bitrates, increase transmit power, |
| | trigger device alert, trigger server side alert. |
| Desired Outcome | Allow the wireless client to maintain connection for as long as |
| | possible until signal strength improves or reaches out-of- |
| | coverage scenario. Trigger an alert on the end device to |
| | inform device software and user of poor coverage area. |
| | Trigger server side alert as to devices in poor coverage area. |
| | Inform server side users as to an area of persistent signal |
| | strength undercoverage if this is a regular problem. |

TABLE 3
Detect out-of-coverage situation due to lack of signal
detection and stay connected via dynamic link failover

| | |
|---|---|
| Optimization Objectives | Automatically set up selective client(s) to convert to dual mode |
| | client and access point or dual mode client and ad-hoc to allow |
| | out of coverage client to stay connected to infrastructure. Alert |
| | user device, server side, and IT staff of out-of-coverage |
| | situation. |
| Required events/data | Each client's current AP BSSID and RSSI, recent client roam |
| | table results, recent client scan results, known client |
| | disconnects and length of disconnect. |
| Analysis/Algorithm | Analysis on management server: Detect if any clients which |
| | had a weak signal strength to their currently connected AP and |
| | no better roam candidates are no longer sending data to the |
| | network. Determine if other clients near the same AP are still |
| | connected to the network. |
| | On out-of-coverage client side: Client recognizes it can no |
| | longer connect to network. |
| Required control parameters | Mode switch trigger, all wireless network configuration, |
| | device alert trigger, server side alert trigger. |
| Required parameter changes | Have client(s) near out-of-coverage client's previous AP |
| | convert to dual client and AP or ad-hoc mode. The dual mode |
| | devices program their AP or ad-hoc mode with network |
| | credentials that the out-of-coverage client will know. Out-of- |
| | coverage client switches credentials to known good out-of- |
| | coverage network settings and attempts to connect. The out- |
| | of-coverage client may also need to switch modes if need be. |
| Desired Outcome | Trigger an alert on the end device to inform device software |
| | and user of out-of-coverage area. Trigger server-side alert as |
| | to devices in out-of-coverage area. Out-of-coverage client |
| | connects to dual-mode device(s), if near, and continues to send |
| | and receive data through dual-mode device(s) to the wireless |
| | infrastructure. |
| | Once an out-of-coverage wireless client is back within range of |
| | access points on network infrastructure, it will switch back to |
| | connecting normally to it. Dual-mode devices would revert to |
| | client only mode. |
| | Inform server side users as to a persistent out-of-coverage area |
| | if this is a regular problem. |

TABLE 4
Detect and optimize for capacity under-coverage

| | |
|---|---|
| Optimization Objectives | Alert user device and IT staff as to capacity under-coverage |
| | issues, optimize wireless client to hold onto connection. |
| Required events/data | Each client's current AP BSSID and RSSI, number of beacon |
| | misses, client roam table results, client scan results, channel |
| | utilization, station count, and admissions capability numbers |
| | from AP, and packet retry counts. |
| Analysis/Algorithm | Detect if any clients have a high number of beacon misses and |
| | packet retry counts despite having adequate signal strength. |
| | Also, determine if a given client's current AP and roam |
| | candidates are on channels with a high utilization rate. Use |
| | historical analysis to determine if this is a regular problem for |
| | clients near certain APs. |
| Required control parameters | Roam and background scan periods, bitrate selection, keep- |
| | alive interval, device alert trigger, server-side alert trigger. |
| Required parameter changes | For all clients in area with capacity under-coverage, if |
| | possible, do the following: decrease the roam scan and |
| | background scan period or turn it off, disable non-OFDM |
| | bitrates and use highest possible bitrates, skip waking up for |
| | DTIM intervals, and lower keep-alive interval. If controlling |
| | multiple clients in the area, on devices sending low priority |
| | data, ask device software to not constantly transmit. Try to |
| | coordinate device software to allow for optimal channel time |
| | usage. |
| Desired Outcome | Allow the wireless clients to maintain an optimal connection |
| | by not contesting for limited wireless channels. Trigger an |
| | alert on the end device to inform device software and user as to |
| | capacity-under-coverage area. Trigger server-side alert of |
| | devices in capacity-under-coverage area. Inform server side |
| | users as to an area of persistent capacity under-coverage if this |
| | is a regular problem. |

TABLE 5
Detect and optimize for dense wireless networks and over-coverage

| | |
|---|---|
| Optimization Objectives | Optimize wireless client to hold onto connection, especially |
| | while roaming. |
| Required events/data | Each client's current AP BSSID and RSSI, client roam table |
| | results, client scan results, accelerometer output. |
| Analysis/Algorithm | Detect if any wireless client has an excessive number of high |
| | signal strength APs for a given area or as it roams throughout |
| | an area. Distinguish between a fast roaming scenario vs. over- |
| | coverage by using data from clients without fast signal changes |
| | or a device that can measure signal change versus motion via |
| | an accelerometer. |
| Required control parameters | Roam and background scan periods, roam thresholds, server |
| | side alert. |
| Required parameter changes | Optimize roam threshold by increasing it to trigger roam scans |
| | sooner, increase roam scan period and background period to |
| | gather scan data more often. Change values until clients in |
| | area roam without skipping APs or roaming to APs that |
| | already have a decreasing signal strength. |
| Desired Outcome | Clients will make better roaming decisions by collecting scan |
| | data faster which will allow a more optimal connection. If |
| | optimal connections cannot be achieved through this method, |
| | trigger server-side alert as to devices being in an over-coverage |
| | area. |

TABLE 6
Detect misconfigured, malfunctioning, or rogue infrastructure and avoid it

| | |
|---|---|
| Optimization Objectives | Determine misconfigured, malfunctioning, or a potential rogue |
| | infrastructure, avoid it, and send a server-side alert. |
| Required events/data | All potential events and data. |
| Analysis/Algorithm | Determine if a client or clients cannot connect to a specific |
| | BSSID but can connect to other BSSIDs using the same |
| | configuration. Determine if a given client or clients can |
| | connect to a given BSSID that has a different configuration |
| | than other BSSIDs. This could be from the automatic |
| | configuration optimization or initial connection. If a list of |
| | known configurations has been programmed in the server side, |
| | compare to see if actual configuration differs vs. known |
| | configurations. |
| Required control parameters | All potential control and configuration parameters, server side |
| | alert trigger. |
| Required parameter changes | All potential control and configuration parameter changes. |
| Desired Outcome | Determine what configurations allow a connection to the |
| | network and if they differ from known configuration list. If |
| | known configuration information is not available, look for |
| | differing configuration or inability to connect. In all cases, |
| | flag the BSSID as an AP to avoid and/or send a server-side |
| | alert. This AP could be a security hole or could be causing |
| | poor network performance. |

TABLE 7
Profile and optimize based on time of day

| | |
|---|---|
| Optimization Objectives | Optimize wireless client for usage based on time of day. |
| Required events/data | All potential events and data, including device side and/or |
| | server side profile optimizations (e.g., low power device, |
| | highly mobile device, high throughput device, etc.), more than |
| | one profile can be suggested. |
| Analysis/Algorithm | Collect all potentially useful events and data from each |
| | wireless client. Then determine if there are any trends in usage |
| | versus time of day. If there are, use the trends to optimize for |
| | identified usage during a given time of day. |
| Required control parameters | All potential control parameters. |
| Required parameter changes | All potential control parameter changes. |
| Desired Outcome | Example could be a device that switches APs often during the |
| | daytime hours but does not move from one AP at night. This |
| | device could be optimized during the day to increase |
| | background scan and roam scan periods to allow for better |
| | roaming and mobility. Then at night, this device could be told |
| | to decrease background scan and roam scan periods to save |
| | power. Set profile optimizations could influence how |
| | parameters are changed. For instance, a profile set to high |
| | throughput may not choose scan periods as aggressively as one |
| | set to highly mobile. If no profiles are chosen, optimization |
| | would be done based on a best analysis of all data available to |
| | determine use cases. |

TABLE 8
Profile and optimize based on device type

| | |
|---|---|
| Optimization Objectives | Optimize wireless client for usage based on type of device. |
| Required events/data | All potential events and data, including device-side and/or |
| | server-side profile optimizations (e.g., low power device, |
| | highly mobile device, high throughput device, etc.), more than |
| | one profile can be suggested. Data to distinguish it as a certain |
| | device type, such as model number or product type. |
| Analysis/Algorithm | Collect all potentially useful events and data from each |
| | wireless client. Then determine if there are any trends in usage |
| | versus what type of end device the wireless client is integrated |
| | with. If there are, use the usage trends to optimize that device |
| | type. |
| Required control parameters | All potential control parameters. |
| Required parameter changes | All potential control parameter changes. |
| Desired Outcome | Example could be a user that is highly mobile but the device |
| | defaults do not allow for optimal roaming choices. This |
| | device type could be optimized to increase background scan |
| | and/or roam scan periods to allow for better roaming and |
| | mobility. Set profile optimizations could influence how |
| | parameters are changed. For instance, a profile set to high |
| | throughput may not choose scan periods as aggressively as one |
| | set to highly mobile. If no profiles are chosen, optimization |
| | would be done based on a best analysis of all data available to |
| | determine use cases. |

TABLE 9
Profile and optimize based on user or user group

| | |
|---|---|
| Optimization Objectives | Optimize wireless client for usage based on a given user or |
| | user group. |
| Required events/data | All potential events and data, including device-side and/or |
| | server-side profile optimizations (e.g., low power device, |
| | highly mobile device, high throughput device, etc.), more than |
| | one profile can be suggested. Data to distinguish the current |
| | and previous users on a given device or all devices, such as |
| | login id, key based authentication, etc. |
| Analysis/Algorithm | Collect all potentially useful events and data from each |
| | wireless client. Then determine if there are any trends in usage |
| | versus a given user or user group on a given device or device |
| | type, or all devices a wireless client is integrated with. If there |
| | are, use the usage trends to optimize for a given user or user |
| | group. |
| Required control parameters | All potential control parameters. |
| Required parameter changes | All potential control parameter changes. |
| Desired Outcome | Example could be a user that is highly mobile but the device |
| | defaults do not allow for optimal roaming choices. When this |
| | user is logged in, the device could be optimized to increase |
| | background scan and/or roam scan periods to allow for better |
| | roaming and mobility. Set profile optimizations could |
| | influence how parameters are changed. For instance, a profile |
| | set to high throughput may not choose scan periods as |
| | aggressively as one set to highly mobile. If no profiles are |
| | chosen, optimization would be done based on a best analysis |
| | of all data available to determine use cases. |

TABLE 10
Profile and optimize based on device location

| | |
|---|---|
| Optimization Objectives | Optimize usage based on device location. |
| Required events/data | All potential events and data, including device-side and/or |
| | server-side profile optimizations (e.g., low power device, |
| | highly mobile device, high throughput device, etc.), more than |
| | one profile can be suggested. Data to distinguish a device's |
| | location, examples could be current BSSID and RSSI, BLE |
| | beacons, GPS location, etc. |
| Analysis/Algorithm | Collect all potentially useful events and data from each |
| | wireless client. Then determine if there are any trends in usage |
| | of the device versus the locations it has been in. If there are, |
| | use the usage trends to optimize that device when in those |
| | locations. |
| Required control parameters | All potential control parameters. |
| Required parameter changes | All potential control parameter changes. |
| Desired Outcome | Example could be a device that passes large amounts of traffic |
| | at a high frequency when near certain BSSIDs but does not |
| | send much traffic when near other BSSIDs. This device could |
| | support 2 separate RF chains (MIMO support) and have an |
| | optimization profile set to saving power. When the device is |
| | located near the BSSIDs where it normally sends large |
| | amounts of traffic, the second RF chain can be activated to |
| | enabled higher throughput and optimal connectivity. When the |
| | device nears the BSSIDs where it is normally idle, if it is not |
| | using much throughput, it could be set to disable the second |
| | RF chain to conserve power. |

TABLE 11
Detect and optimize based on multiple regulatory domains

| | |
|---|---|
| Optimization Objectives | Detect if multiple country codes are being used on the |
| | network, enforce intersection of country codes if necessary. |
| Required events/data | All current country codes seen by clients in network, GPS |
| | location or other location information. |
| Analysis/Algorithm | Compare all country codes seen on network, if more than one |
| | exists, trigger an alert. If required by local regulatory body, |
| | enforce an intersection of channels between seen country |
| | codes. If GPS or other location data is available, use that to |
| | determine correct country code and enforce that regulatory |
| | domain on the clients. |
| Required control parameters | Server side alert trigger, channel list. |
| Required parameter changes | Trigger a service side alert if multiples are found. If needed, |
| | set the intersection of channels on all country codes on all |
| | devices to remain compliant. |
| Desired Outcome | Alert administrators to a regulatory compliance issue. If |
| | needed, assert the intersection of regulatory domains on all |
| | controllable clients. |

TABLE 12
Automatic configuration testing

| | |
|---|---|
| Optimization Objectives | Determine what configurations allow connection to the |
| | network. |
| Required events/data | All potential events and data. |
| Analysis/Algorithm | If a client cannot connect or is idle, cycle through all known |
| | connection parameters, such as bitrates and EAP types. If a |
| | certain configuration combination connects, inform server of |
| | that configuration upon connection. If a list of known |
| | configurations has been programmed in the server side, |
| | compare to see if actual configuration differs vs. known |
| | configurations. |
| Required control parameters | All potential control and configuration parameters, device alert |
| | trigger, server side alert trigger. |
| Required parameter changes | All potential control and configuration parameter changes. |
| Desired Outcome | Determine what configurations allow connection to the |
| | network, and if they differ from a known configuration list, |
| | trigger a server side alert. Such a configuration could be a |
| | security hole or could be causing poor network performance. |

TABLE 13
Improve connectivity via channel list optimization

| | |
|---|---|
| Optimization Objectives | Faster connection and roaming time, lower power usage, and |
| | higher throughput. |
| Required events/data | Scan results for current network |
| Analysis/Algorithm | Gather scan results from clients and determine channels |
| | network is operating on. |
| Required control parameters | Channel list. |
| Required parameter changes | Limit channel list to only channels BSSIDs are seen on. |
| Desired Outcome | Scans are faster due to a short channel list, allowing for a faster |
| | best roam candidate decision. Scanning fewer channels allows |
| | for more time to be spent on home channel, allowing for |
| | higher throughput. Scanning less consumes less energy since |
| | the client may spend less time in transmit and receive mode |
| | and more time sleeping. |

TABLE 14
Improve connectivity via channel dwell time

| | |
|---|---|
| Optimization Objectives | Faster connection and roaming time, lower power usage, and |
| | higher throughput. |
| Required events/data | Scan results for current network per scan per dwell time. |
| Analysis/Algorithm | Tell clients to do a scan with a given channel dwell time. |
| | Gather scan results. Decrement scan dwell time until scan |
| | results become too limited. |
| Required control parameters | Active and passive scan channel dwell time. |
| Required parameter changes | Increase or decrease scan dwell time until optimal amount of |
| | scan results are found. |
| Desired Outcome | Scans take less time due to choosing an optimal channel dwell |
| | (vs. a fixed conservative dwell time) allowing for a faster best |
| | roam candidate decision. Scans taking less time allow for |
| | more time to be spent transacting packets, allowing for higher |
| | throughput. Scans taking less time consume less energy since |
| | the client may spend less time in transmit and receive mode |
| | and more time sleeping. |

TABLE 15
Bias connection candidate based on channel and/or access point usage

| | |
|---|---|
| Optimization Objectives | Optimize BSSID selection based on channel and/or access |
| | point usage. |
| Required events/data | Each client's current AP BSSID, RSSI, and channel, number |
| | of beacon misses, client roam table results, client scan results, |
| | channel utilization, station count, and admissions capability |
| | numbers from APs, and packet retry counts. |
| Analysis/Algorithm | Detect if any clients have a high number of beacon misses and |
| | packet retry counts despite having an adequate signal strength. |
| | For channel usage, determine if a given client's current AP and |
| | nearby APs are on channels with a high utilization rate. For |
| | access point usage, determine how many clients are connected |
| | to current AP and nearby APs. Determine if there are BSSIDs |
| | nearby on channels with lower utilization rates and/or less |
| | overall clients on BSSIDs. |
| Required control parameters | Bias certain BSSIDs in a client's roam/connection table. |
| Required parameter changes | Positively bias BSSIDs on less utilized channels and/or with |
| | less connected clients. |
| Desired Outcome | Clients connect to a positively biased BSSID which is on a |
| | channel with lower utilization and/or less connected clients, |
| | despite having a weaker signal to a BSSID that is not |
| | positively biased. This improves the overall network |
| | efficiency and allows the current client to increase throughput |
| | or save power by having a less crowded channel and/or access |
| | point to operate on. |

TABLE 16
Bias connection candidates based on other client's performance

| | |
|---|---|
| Optimization Objectives | Optimize BSSID selection based on other client's performance |
| Required events/data | All potential events and data. |
| Analysis/Algorithm | If a given device is experiencing non-optimal connectivity on a |
| | certain BSSID, determine if nearby devices are achieving |
| | optimal connectivity on other BSSIDs. |
| Required control parameters | Bias certain BSSIDs in a client's roam/connection table. |
| Required parameter changes | Positively bias nearby BSSIDs that other devices are |
| | experiencing optimal connectivity on. |
| Desired Outcome | Device connects to a positively biased BSSID which should |
| | allow better connectivity, despite having a stronger signal to a |
| | BSSID that is not positively biased. This allows device to |
| | achieve better connectivity on a BSSID that would be |
| | normally ranked lower in a roam/connection table. |

TABLE 17
Detect and optimize for non-optimal infrastructure configuration

| | |
|---|---|
| Optimization Objectives | Detect and optimize for non-optimal infrastructure |
| | configuration and send a server side alert. |
| Required events/data | All potential events and data. |
| Analysis/Algorithm | Determine if one or more clients has issues connecting or |
| | staying connected to a specific BSSID or the whole network. |
| | Determine if infrastructure configuration parameters, e.g., |
| | authentication handshake timeouts, activity timeouts, allowed |
| | bitrates, DTIM intervals, channel selection per neighboring |
| | BSSID, etc., are set to non-optimal values. This could be from |
| | the automatic configuration testing or normal events and data. |
| Required control parameters | All potential control and configuration parameters, server side |
| | alert trigger. |
| Required parameter changes | All potential control and configuration parameter changes. |
| Desired Outcome | Example is a client or clients trying to use an EAP type |
| | authentication to connect to the network and seeing EAPOL |
| | retry packets too soon. This could cause EAP authentication |
| | to start again. Automatic configuration testing could also send |
| | an EAPOL packet and not respond to the infrastructure to see |
| | when the retry packet occurs. If this retry comes too soon, |
| | then this is a poor EAP packet timeout that should be |
| | increased. When the client or clients finally connects to the |
| | network, send a server side alert to change the EAP packet |
| | timeouts on the infrastructure. If the server has access to |
| | change infrastructure parameters, allow it to change to a better |
| | parameter. |

18. Optimize other collocated wireless
devices of differing wireless technology

| | |
|---|---|
| Optimization | Optimize other collocated wireless devices that are a |
| Objectives | different wireless technology |
| Required | all potential events and data |
| events/data | |
| Analysis/ | Determine if there are other collocated wireless |
| Algorithm | devices near the client and what wireless technology |
| | those devices are using. If there is communication |
| | access to these collocated wireless devices, |
| | determine if they are sharing the same wireless |
| | spectrum as the client. If so, inform the wireless |
| | devices of information on how the client and client's |
| | infrastructure are using the wireless spectrum. This |
| | can be what frequencies are being used, when they |
| | are being used, or other information related to the |
| | spectrum use. |
| Required control | all potential control and configuration parameters of |
| parameters | the collocated wireless device |
| Required | all potential control and configuration parameter |
| parameter | changes of the collocated wireless device |
| changes | |
| Desired Outcome | Example is a client with a collocated Bluetooth |
| | wireless device. If the client and Bluetooth device are |
| | both operating on the same band (i.e. 2.4 GHz), inform |
| | the Bluetooth client of the frequencies in the channels |
| | the client and the client's infrastructure are operating |
| | on. The Bluetooth device can then attempt to select |
| | frequencies that are not being used by the client |
| | and/or the rest of the infrastructure. |

Another way of diagnosing and/or optimizing for connectivity issues is to look for previously unknown trends, patterns, and correlations between data and events and the corresponding location, time, configuration, etc. This may allow a wireless management server to find new configuration optimizations that were previously unknown that allow for better connectivity.

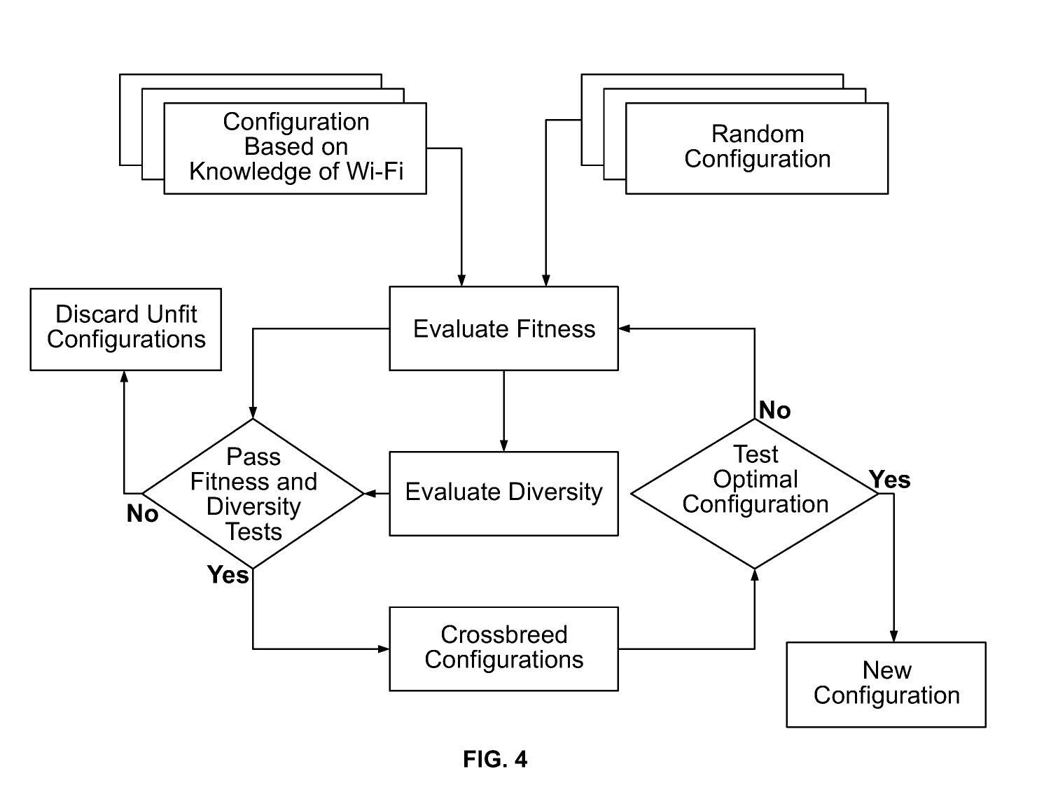

For various forms of diagnosing and optimizing connectivity issues, artificial intelligence (AI) may be used to aid in the optimization of wireless clients and wireless infrastructure. For example, there may be several known potential permutations of configuration to optimize for a given connectivity scenario. A genetic algorithm may start with known permutations of potential configurations and test them to determine their fitness. The algorithm may then crossbreed the configurations to test for optimal fitness while making sure they are sufficiently diverse. When an optimal configuration is found, it may be used by a client or clients until connectivity is found not to be optimal. A flow diagram of one example embodiment of a genetic algorithm is shown in FIG. 4.

AI may be used, e.g., in diagnosing and optimizing poor connectivity situations where no known diagnostic technique works and no previously unknown correlations, patterns, or trends between data and events and configuration have been found. In such cases, a genetic algorithm may be used to select and test different, potentially random, configurations and determine their fitness. The algorithm may then crossbreed the configurations to test for optimal fitness while making sure they are sufficiently diverse. When an optimal configuration is found, it may be used by a client or clients, e.g., until connectivity is found not to be optimal.

Other or additional optimizations to wireless clients exist and can address more than basic connectivity issues. A wireless management server may optimize connectivity for a variety of use cases. The previously described techniques may be used to find and optimize for such cases, which may be related to power consumption, time, device type, device user, etc. Tables 1-18 describe various connectivity optimizations that could be use cases.

What use cases a given wireless client should be optimized for can be explicitly set, determined during client operation, or both. In an explicitly set case, a device manufacturer integrating a wireless client may provide explicit use cases to the wireless client on how a given client should operate. Additionally or alternatively, a wireless network administrator may program explicit use cases into a wireless management server on how a given client or class of clients should operate. In cases where no explicit use cases have been provided, a wireless management server and/or wireless client may determine which use case(s) to optimize for based on analyzing collected historical data and events. Even where an explicit use case has been programmed, a wireless management server may still determine to optimize for other use cases beyond the ones explicitly programmed.

In the embodiment shown in FIG. 2, each wireless client 204 has its own management agent 226. The management agents 226 on each wireless client 204 may collect data and events related to the wireless connection. The collected data and events may be sent, at an appropriate time, to the wireless management server 210, e.g., over a UDP or TCP IP connection. The wireless management server 210 may collect data and events from the monitoring devices 238 of the fixed overlay monitoring network 230. The wireless management server 210 may collect data and events from the mobile diagnostic device 242. The wireless management server 210 may then determine if there are any connectivity issues that the wireless client 204a, wireless client 204b, or wireless client 204c is experiencing on the wireless network. If there are issues, the wireless management server 210 may analyze the events and data from a plurality of wireless clients to determine if it can find a set of client configuration parameters that can be sent to the wireless client 204a, wireless client 204b, or wireless client 204c for optimizing that client's connectivity. If that is so, the wireless management server 210 may send those parameters to the appropriate management agent 226 to apply those parameters to the agent's wireless client 204 at an appropriate time. If the wireless management server 210 determines that the issues could be fixed or optimized by adjusting parameters on the controller 220 and/or one or more of the access points 214, the wireless management server 210 may send an alert to the wireless network administrator to make adjustments to those devices. If the wireless management server 210 is able to directly make adjustments to those devices, it may make the adjustments and send an alert to the wireless network administrator as to what adjustment it made. Additionally or alternatively, the wireless management server 210 may look to optimize each wireless client 204 for a specific connectivity use case. Such a connectivity use case could be one of the optimizations in Tables 1-18 or some other optimization.

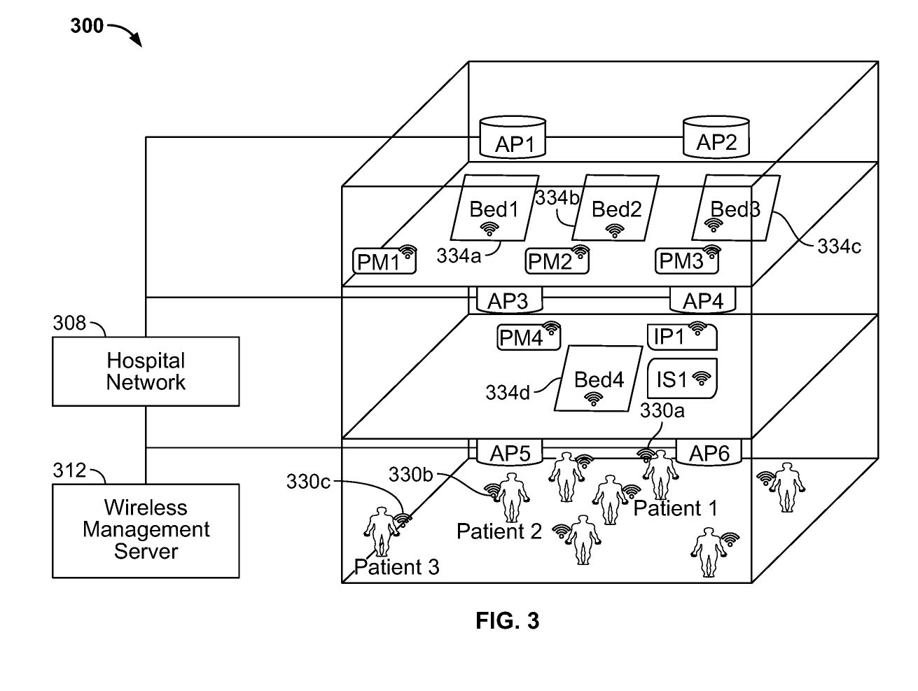

Another example embodiment of a communications network or system is indicated generally in FIG. 3 by reference number 300. The system 300 may be used, e.g., for managing actions performable by a plurality of distributed devices in a hospital environment. A hospital network 308, which can include typical computer networking equipment, is connected with wireless network infrastructure that includes a plurality of (in the present example, six) access points (APs) AP1 through AP6. A wireless management server 312 is connected with AP1 through AP6 via the hospital network 308. The wireless management server 312 receives data and events from wireless clients integrated with various devices in the hospital. Such devices include portable patient monitors 330a-330c provided respectively on three ambulatory patients. Other devices having wireless clients include one or more (in the present example, four) patient bed monitors 334a-334d, one or more (in the present example, four) stationary patient monitors PM1-PM4, one or more (in the present example, one) infusion pump IP1, and one or more (in the present example, one) information station IS1. Each wireless client has a management agent, e.g., as previously discussed with reference to FIG. 2. The management agents are configured to send data and events to the wireless management server 312.

In one example embodiment, the system 300 detects and optimizes for edge of coverage, e.g., as described in Table 1. The wireless management server 312 determines that the wireless clients integrated with the portable patient monitor 330c and the stationary patient monitor PM1 transmit weak signal strength to their currently connected access points, AP5 and AP1 respectively, and there are no better roam candidates. The wireless management server 312 then determines new optimal wireless client configuration parameters to maintain connectivity for the portable patient monitor 330c and the stationary patient monitor PM1. The parameters are then sent to the portable patient monitor 330c and the stationary patient monitor PM1 to be applied. The parameters may allow a wireless client to maintain connection for as long as possible until signal strength improves or reaches an out-of-coverage scenario. The management agents may trigger an alert on portable patient monitor 330c and the stationary patient monitor PM1 to inform any local user of the poor connectivity. Additionally or alternatively, the wireless management server 312 may trigger an alert, e.g., to go to a nurses' station connected with the hospital network 308 to tell a nurse to move the stationary patient monitor PM1 to a better coverage area. In the case of the portable patient monitor 330c, the alert sent by the management agent for the portable patient monitor 330c may inform the patient wearing the portable patient monitor 330c to move to a better coverage area. Additionally or alternatively, the wireless management server 312 may tell the nursing station that the patient wearing the portable patient monitor 330c has moved to a poor coverage area.

In another example embodiment, the system 300 profiles and optimizes based on time of day, e.g., as described in Table 7. The portable patient monitors 330a, 330b and 330c worn by three patients ideally use minimal power in order to conserve battery life, but since the monitors are attached to patients, they are highly mobile and need to roam in the wireless network 308 as the patient moves. In the present example embodiment, the wireless management server 312 determines that at night, while people normally sleep, the wireless clients on the portable patient monitors 330a, 330b and 330c are not mobile and do not move. Also, the wireless management server 312 determines that the wireless clients of the portable patient monitors 330a, 330b and 330c roam between several access points during the daytime hours. The wireless management server 312 determines to optimize the wireless clients of the portable patient monitors 330a, 330b and 330c by sending configuration parameters to their management agents to be optimized during the day to allow for better roaming and mobility. Then at night, the wireless management server 312 may send configuration parameters to optimize the wireless clients of the portable patient monitors 330a, 330b and 330c to save power. Thus optimal power savings can be allowed when appropriate, and reliable and fast roaming can be provided when needed.

In another example embodiment, the system 300 detects and optimizes for capacity under-coverage, e.g., as described in Table 4. The wireless management server 312 determines that the wireless client of the portable patient monitor 330a, which at that time is using the access point AP6, is experiencing difficulty in staying connected and in passing traffic, despite adequate signal strength. The wireless management server 312 issues scans from most, if not all, available clients in the area, including clients of other portable patient monitors 330, to determine whether the access point AP6 and the channel used by the portable patient monitor 330a are highly utilized. The wireless management server 312 may send wireless client configuration parameters to the management agent of the portable patient monitor 330a to connect to the access point AP5, even though the access point AP5 has a lower signal strength. This would allow the portable patient monitor 330a to maintain an optimal connection by not contesting for limited channel and AP capacity on the access point AP6. Since a wireless infrastructure adjustment may be warranted, the wireless management server 312 may send an alert, e.g., to a wireless network administrator detailing the capacity under-coverage and potential resolutions.

In another example embodiment, the system 300 improves connectivity via channel list optimization, e.g., as described in Table 13. The wireless management server 312 may gather scan results from all the clients in the hospital. The wireless management server 312 may then determine all the channels on which access points AP1-AP5 are operating. The wireless management server 312 may then send a configuration parameter list containing the channels used by the wireless network to all wireless clients' management agents. The management agents may set the wireless clients to only operate on those channels. The wireless clients thus can be allowed to finish scans faster due to a shorter channel list, thereby allowing wireless clients to achieve faster roaming, higher throughput, and consume less energy.

In another example embodiment, the system 300 improves connectivity based on device type, e.g., as described in Table 8. The wireless management server 312 gathers events and data from devices of a specific type, e.g., the portable infusion pump IP1 sending large amounts of data regarding the drugs administered to a patient on to the nurses station IS1. The infusion pump IP1 is not highly mobile and stays connected to the access point AP4. This behavior is similar to that of previous infusion pump IP1-type devices on the system 300. The wireless management server 312 determines to optimize devices of the type of infusion pump IP1 based on the usage trend of needing high throughputs and not high mobility for that device type.

Embodiments of the foregoing network systems and methods can enable the performance of an individual device client to be tuned based on that client's activities and/or based on activities of clients of other devices in the network. This is in contrast to networks that tune overall network performance without regard to behavior of individual clients. Various embodiments make it possible to tune performance of clients not only in response to the wireless environment, but also in ways that address behaviors of the devices for which the individual clients are provided.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of a device in use or operation in addition to the orientation depicted in the figures. For example, if a device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A network comprising:
a wireless network infrastructure; and
a plurality of devices having clients integrated therewith and configured for wireless communication via the wireless infrastructure and for communication with a server;
each client configured to acquire data relevant to one or more network conditions affecting performance by the client in the network, each client further configured to send the acquired data to the server;
wherein the server is configured to, based on the acquired data, send instruction to one or more of the clients via the wireless infrastructure to adjust one or more operating parameters to tune performance in the network of the one or more of the clients.

2. The network of claim 1, wherein a given client is further configured to, based on the acquired data, provide an alert to the device with which the given client is integrated, the alert regarding one or more network conditions affecting performance by the given client.

3. The network of claim 2, wherein the one or more network conditions comprise being in a wireless environment area in which there is poor wireless coverage.

4. The network of claim 1, wherein:
the server and/or a given client is configured to use the data acquired by the given client to evaluate the one or more network conditions; and
the server is further configured to, based on the evaluating, send instruction to one or more of the clients to adjust one or more operating parameters to tune performance of the one or more of the clients.

5. The network of claim 4, wherein the server and/or given client is further configured to, based on the evaluating, provide an alert to the device with which the given client is integrated, the alert regarding one or more network conditions affecting performance by the given client.

6. The network of claim 4, wherein the server and/or a given client is further configured to, based on the evaluating, provide an alert to the server to which a given client is connected, the alert regarding one or more network conditions affecting performance by a given client.

7. The network of claim 1, wherein the one or more network conditions comprise one or more of the following: poor wireless coverage, network over-coverage, signal strength, edge of coverage, capacity under-coverage, out-of-coverage, poor or misconfigured infrastructure, rogue infrastructure, channel conditions, access point load, performance by another client, time of day, device location, regulatory domain, device type, user, user group, and co-located different wireless technologies.

8. The network of claim 1, wherein the data relevant to one or more network conditions affecting performance comprise data descriptive of one or more of the following: ease and/or difficulty of roaming, throughput, and signal quality.

9. The network of claim 8, wherein at least some of the data comprises historical data.

10. The network of claim 1, wherein the one or more operating parameters to tune performance comprise parameters for one or more of the following: roaming, throughput, power consumption, and quality of connection.

11. The network of claim 1, wherein a given client is integrated with one of the following devices: a medical device, a device used within a wireless network, and a monitoring device.

12. A method of tuning performance of communication in a wireless network, the method comprising:
one or more wireless-capable clients of the wireless network acquiring data relevant to one or more network conditions affecting wireless network performance by the one or more clients in a wireless environment, and sending the acquired data to a server; and
based on the acquired data:
the server sending instruction to a given client to adjust one or more operating parameters to tune performance of the given client, and/or one or both of the server and the given client providing an alert to a device with which the given client is integrated.

13. The method of claim 12, further comprising:
the server and/or a given client, based on the acquired data, providing an alert to the server to which a given client is connected, the alert regarding one or more network conditions affecting performance by a given client.

14. The method of claim 12, further comprising:
one or more mobile wireless network diagnostic devices gathering data and/or sending events to the server; and
the server using the data to analyze connectivity.

15. The method of claim 12, further comprising:
an agent of a given client coordinating with one or more mobile wireless network diagnostic devices and/or one or more other wireless clients to obtain data;
the coordinating performed over one or more of the following: a wireless connection to wireless infrastructure, a separate wireless connection, and a physical network connection.

16. The method of claim 12, further comprising:
an out-of-coverage client determining that it is out of coverage by a given access point; and
signaling another client near the given access point to switch from client mode to an access point or ad-hoc mode to allow the out-of-coverage client to connect at least temporarily to the client in the access point or ad-hoc mode.

17. The method of claim 12, further comprising:
determining whether a wireless device near a given client and using a different wireless technology shares the same spectrum as the given client; and
optimizing the nearby wireless device relative to use of the same spectrum by the given client and/or by infrastructure of the given client.

18. The method of claim 12, wherein the alert indicates the device is in a wireless environment area in which there is poor wireless coverage.

19. The method of claim 12, wherein the data relevant to one or more network conditions affecting performance comprises data descriptive of one or more of the following: beacon miss, ease and/or difficulty of roaming, throughput, and signal quality.

20. The method of claim 12, wherein the one or more operating parameters to tune performance comprise parameters for one or more of the following: roaming, power consumption throughput, and quality of connection.

21. A system comprising:
a wireless network infrastructure;
an overlay network configured to monitor the wireless infrastructure and to acquire data relevant to one or more network conditions; and
a plurality of devices having clients of a server and configured for wireless communication with the server via the wireless infrastructure;
each client configured to acquire data relevant to one or more network conditions affecting performance by the client in the wireless environment, each client further configured to send the acquired data to the server;
wherein the server is further configured to, based on the data acquired by the overlay network and the data acquired by the clients, send instruction to one or more of the clients to adjust one or more operating parameters to tune performance of the one or more of the clients.

22. The system of claim 21, wherein:
a given client and/or the server is further configured to, based on the data acquired by the given client and/or by the overlay network, provide an alert to the device having the given client, the alert regarding one or more network conditions affecting performance by the given client.

23. The system of claim 22, wherein the one or more network conditions comprise being in a wireless environment area in which there is poor wireless coverage.

24. The system of claim 21, wherein:
the server and/or a given client is configured to use the data acquired by the given client and/or by the overlay network to evaluate the one or more network conditions; and
the server is further configured to, based on the evaluating, send instructions to one or more of the clients to adjust one or more operating parameters to tune performance of the one or more of the clients.

25. The system of claim 21, wherein the data relevant to one or more network conditions affecting performance comprises data descriptive of one or more of the following: ease and/or difficulty of roaming, throughput, and signal quality.

26. The system of claim 21, wherein:
the one or more operating parameters to tune performance comprise parameters for one or more of the following: roaming, power consumption, throughput, and connection quality; and/or
a given client is integrated with one of the following devices: a medical device, a device used within a wireless network, and a monitoring device.
